(19) United States
(12) Patent Application Publication
(10) Pub. No.: US 2012/0194947 A1
(43) Pub. Date: Aug. 2, 2012

(54) VOLTAGE REGULATOR

(76) Inventor: Takao Nakashimo, Chiba-shi (JP)

(21) Appl. No.: 13/355,746

(22) Filed: Jan. 23, 2012

(30) Foreign Application Priority Data
Jan. 28, 2011 (JP) 2011-017050

(51) Int. Cl. H02H 7/20

(52) U.S. Cl. 361/18

(57) ABSTRACT

Provided is a voltage regulator capable of providing overcurrent protection without increasing current consumption even when an output current increases. An overcurrent protection circuit includes: a sense resistor provided to a drain of an output transistor, for sensing an output current; an offset comparator for comparing voltages at both terminals of the sense resistor; and a first transistor including a gate connected to an output of the offset comparator. A current path between a detection transistor and the sense resistor is eliminated, and hence a current for detection does not increase even when an output current is large.

### RELATED APPLICATIONS

This application claims priority under 35 U.S.C. §119 to Japanese Patent Application No. 2011-017050 filed on Jan. 28, 2011, the entire content of which is hereby incorporated by reference.

### BACKGROUND OF THE INVENTION

1. Field of the Invention

The present invention relates to an overcurrent protection circuit of a voltage regulator.

2. Description of the Related Art

A conventional voltage regulator is described. FIG. 5 is a circuit diagram illustrating the conventional voltage regulator.

The conventional voltage regulator includes a reference voltage circuit 101, a differential amplifier circuit 102, a PMOS transistor 104, an overcurrent protection circuit 550, resistors 105 and 106, a ground terminal 100, an output terminal 121, and a power supply terminal 150. The overcurrent protection circuit 550 includes NMOS transistors 505, 506, and 510, PMOS transistors 501, 502, 503, and 504, a constant current circuit 507, and resistors 508 and 509. A voltage 511 added to a source of the PMOS transistor 503 represents an offset voltage of a differential pair of the PMOS transistors 503 and 504.

Connection is made as follows. The differential amplifier circuit 102 has an inverting input terminal connected to any one terminal of the reference voltage circuit 101, a non-inverting input terminal connected to a connection point between any one terminal of the resistor 105 and any one terminal of the resistor 106, and an output terminal connected to a gate of the PMOS transistor 104, a gate of the PMOS transistor 502, and a drain of the PMOS transistor 501. The other terminal of the reference voltage circuit 101 is connected to the ground terminal 100. The PMOS transistor 104 has a source connected to the power supply terminal 150 and a drain connected to the output terminal 121 and the other terminal of the resistor 105. The other terminal of the resistor 106 is connected to the ground terminal 100. The PMOS transistor 501 has a gate connected to a connection point between a drain of the NMOS transistor 510 and any one terminal of the resistor 509, and a source connected to the power supply terminal 150. The other terminal of the resistor 509 is connected to the power supply terminal 150. The PMOS transistor 502 has a drain connected to a connection point between a gate of the PMOS transistor 504 and any one terminal of the resistor 508, and a source connected to the power supply terminal 150. The other terminal of the resistor 508 is connected to the ground terminal 100. The PMOS transistor 503 has a gate connected to the connection point between the one terminal of the resistor 105 and the one terminal of the resistor 106, a drain connected to a drain of the NMOS transistor 505, and a source connected to the constant current circuit 507. The PMOS transistor 504 has a drain connected to a drain and a gate of the NMOS transistor 506 and a gate of the NMOS transistor 505, and has a source connected to the constant current circuit 507. The NMOS transistor 505 has a source connected to the ground terminal 100, and the NMOS transistor 506 has a source connected to the ground terminal 100. The NMOS transistor 510 has a gate connected to the drain of the PMOS transistor 503 and a source connected to the ground terminal 100 (see, for example, Japanese Patent Application Laid-open No. 2006-309569).

The overcurrent protection circuit 550 described above operates as follows to have a function of protecting the voltage regulator from an overcurrent.

When an output current of the output terminal 121 increases, a detection current proportional to the output current flows through the PMOS transistor 502. This detection current flows through the resistor 508, and hence a gate voltage of the PMOS transistor 504 rises. At this time, if an overcurrent flows to the output terminal 121 and, due to the detection current proportional thereto, the gate voltage of the PMOS transistor 504 exceeds a voltage obtained by adding a gate voltage of the PMOS transistor 503 and the offset voltage 511, then the transistor 510 is turned ON. Therefore, a gate-source voltage of the PMOS transistor 501 decreases and a drain current flows, thereby raising a gate-source voltage of the PMOS transistor 104. Feedback works in this way, to thereby suppress the increase in the output current.

In the conventional technology, however, when the output current increases, the current flowing through the resistor 508 increases. Therefore, there is a problem that current consumption increases.

### SUMMARY OF THE INVENTION

The present invention has been made in view of the above-mentioned problem, and provides a voltage regulator in which current consumption does not increase even when an output current increases.

According to the present invention, there is provided a voltage regulator, including: an error amplifier circuit for amplifying and outputting a difference between a reference voltage and a divided voltage obtained by dividing a voltage output by an output transistor, to thereby control a gate of the output transistor; and an overcurrent protection circuit for monitoring an output current of the output transistor to protect the voltage regulator from an overcurrent, in which the overcurrent protection circuit includes: a sense resistor provided to a drain of the output transistor, for sensing the output current; an offset comparator including an input terminal provided with an offset voltage, for comparing voltages at both terminals of the sense resistor; and a first transistor including a gate connected to an output terminal of the offset comparator, and a drain connected to the gate of the output transistor.

According to the voltage regulator including the overcurrent protection circuit of the present invention, the current is detected by the voltage of the resistor connected to the drain of the output transistor. Therefore, overcurrent protection can be provided without increasing current consumption.

### BRIEF DESCRIPTION OF THE DRAWINGS

In the accompanying drawings:

FIG. 1 is a circuit diagram illustrating a voltage regulator according to a first embodiment of the present invention;

FIG. 2 is a circuit diagram illustrating a voltage regulator according to a second embodiment of the present invention;

FIG. 3 is a circuit diagram illustrating a voltage regulator according to a third embodiment of the present invention;

FIG. 4 is a circuit diagram illustrating a voltage regulator according to a fourth embodiment of the present invention; and

FIG. 5 is a circuit diagram illustrating a conventional voltage regulator.

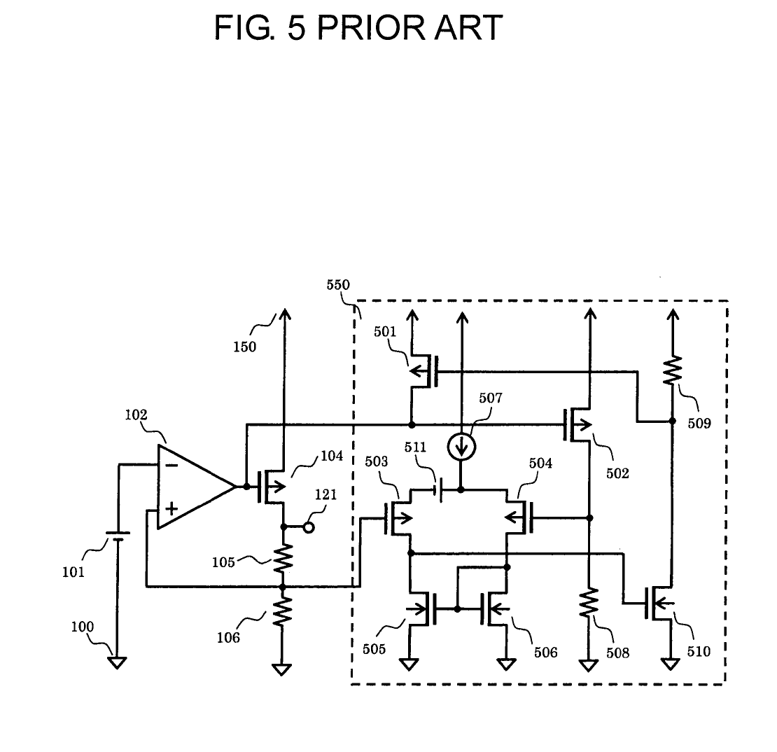

### DETAILED DESCRIPTION OF THE PREFERRED EMBODIMENTS

Referring to the accompanying drawings, embodiments of the present invention are described.

### First Embodiment

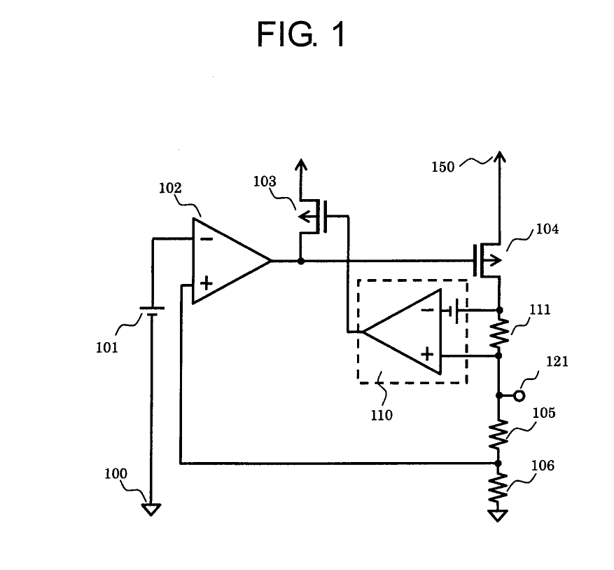

FIG. 1 is a circuit diagram of a voltage regulator according to a first embodiment of the present invention.

The voltage regulator of the first embodiment includes a reference voltage circuit 101, a differential amplifier circuit 102, an offset comparator 110, PMOS transistors 103 and 104, resistors 111, 105, and 106, a ground terminal 100, an output terminal 121, and a power supply terminal 150.

Connection is made as follows. The differential amplifier circuit 102 has an inverting input terminal connected to any one terminal of the reference voltage circuit 101, a non-inverting input terminal connected to a connection point between any one terminal of the resistor 105 and any one terminal of the resistor 106, and an output terminal connected to a gate of the PMOS transistor 104 and a drain of the PMOS transistor 103. The other terminal of the reference voltage circuit 101 is connected to the ground terminal 100. The PMOS transistor 103 has a gate connected to an output of the offset comparator 110 and a source connected to the power supply terminal 150. The PMOS transistor 104 has a drain connected to any one terminal of the resistor 111 and an inverting input terminal of the offset comparator 110, and has a source connected to the power supply terminal 150. The other terminal of the resistor 111 is connected to a non-inverting input terminal of the offset comparator 110, the output terminal 121, and the other terminal of the resistor 105. The other terminal of the resistor 106 is connected to the ground terminal 100.

Next, an operation of the voltage regulator of the first embodiment is described.

The resistors 105 and 106 output a divided voltage Vfb by dividing an output voltage Vout, which is a voltage at the output terminal 121. The differential amplifier circuit 102 compares the divided voltage Vfb with an output voltage Vref of the reference voltage circuit 101 to control a gate voltage of the PMOS transistor 104, which operates as an output transistor, so that the output voltage Vout becomes constant. When the output voltage Vout is higher than a predetermined voltage, the divided voltage Vfb is higher than the reference voltage Vref. Then, an output signal of the differential amplifier circuit 102 (gate voltage of the PMOS transistor 104) becomes higher to gradually turn OFF the PMOS transistor 104, and the output voltage Vout decreases. In this way, the output voltage Vout is controlled to be constant. On the other hand, when the output voltage Vout is lower than the predetermined voltage, an operation reverse to the above-mentioned operation is performed to increase the output voltage Vout. In this way, the output voltage Vout is controlled to be constant.

When the output terminal 121 and the ground terminal 100 are short-circuited, an output current Iout increases. When the output current Iout becomes an overcurrent state exceeding a maximum output current Im, a voltage generated by the resistor 111 increases, and the offset comparator 110 outputs Lo. Then, the PMOS transistor 103 is gradually turned ON, and a gate-source voltage of the PMOS transistor 104 decreases to gradually turn OFF the PMOS transistor 104. Accordingly, the amount of the output current Iout flowing does not exceed the maximum output current Im, and the output voltage Vout decreases. The maximum output current Im is determined by adjusting the resistor 111 so that the voltage of the resistor 111 generated under the short-circuit may be equal to an offset voltage of the offset comparator 110.

In the normal state, the voltage at the non-inverting input terminal of the offset comparator 110 is set higher than the voltage at the inverting input terminal thereof because of the offset voltage, and hence the offset comparator 110 outputs Hi to turn OFF the PMOS transistor 103.

Here, various methods involving setting the offset voltage of the offset comparator 110 are known, such as varying the element size between input transistors, and any method may be employed. Further, the resistor 111 may use a wiring resistor.

In this way, overcurrent protection can be provided by detecting the output current by the resistor 111. Then, the overcurrent protection can be provided without increasing current consumption caused by the increase in the output current.

### Second Embodiment

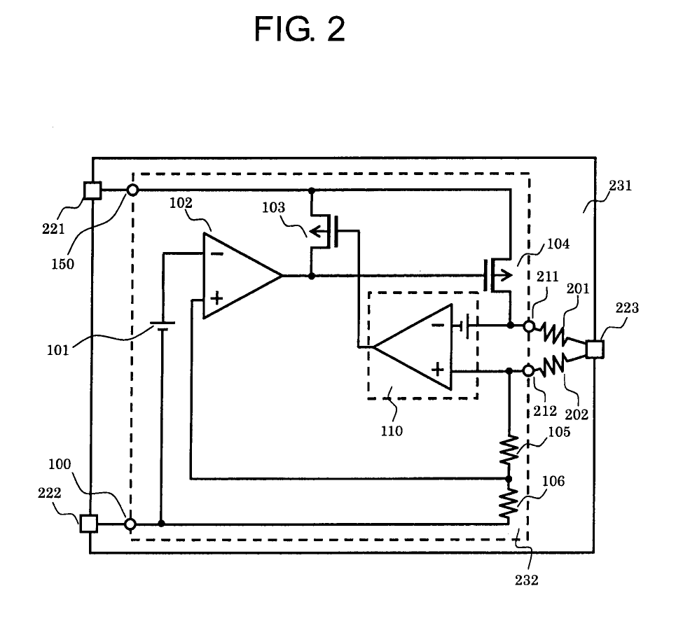

FIG. 2 is a circuit diagram of a voltage regulator according to a second embodiment of the present invention.

FIG. 2 is different from FIG. 1 in that bonding resistors 201 and 202 are used instead of the resistor 111 so that a voltage regulator 232 operates on a package 231.

Connection is made as follows. The power supply terminal 150 is connected to a package power supply terminal 221, and the ground terminal 100 is connected to a package ground terminal 222. The drain of the PMOS transistor 104 is connected to an output terminal 211, and the non-inverting input terminal of the offset comparator 110 is connected to an output terminal 212. The bonding resistor 201 has one terminal connected to the output terminal 211 and the other terminal connected to a package output terminal 223. The bonding resistor 202 has one terminal connected to the output terminal 212 and the other terminal connected to the package output terminal 223. The other connection is the same as that of the first embodiment of FIG. 1.

Next, an operation of the voltage regulator of the second embodiment is described.

The resistors 105 and 106 output a divided voltage Vfb by dividing an output voltage Vout, which is a voltage at the package output terminal 223. The differential amplifier circuit 102 compares the divided voltage Vfb with an output voltage Vref of the reference voltage circuit 101 to control a gate voltage of the PMOS transistor 104, which operates as an output transistor, so that the output voltage Vout becomes constant. When the output voltage Vout is higher than a predetermined voltage, the divided voltage Vfb is higher than the reference voltage Vref. Then, an output signal of the differential amplifier circuit 102 (gate voltage of the PMOS transistor 104) becomes higher to gradually turn OFF the PMOS transistor 104, and the output voltage Vout decreases. In this way, the output voltage Vout is controlled to be constant. On the other hand, when the output voltage Vout is lower than the predetermined voltage, an operation reverse to the above-mentioned operation is performed to increase the output voltage Vout. In this way, the output voltage Vout is controlled to be constant.

When the package output terminal 223 and the package ground terminal 222 are short-circuited, an output current Iout increases. When the output current Iout becomes an overcurrent state exceeding a maximum output current Im, a voltage generated by the bonding resistor 201 increases, and the offset comparator 110 outputs Lo. Then, the PMOS transistor 103 is gradually turned ON, and a gate-source voltage of the PMOS transistor 104 decreases to gradually turn OFF the PMOS transistor 104. Accordingly, the amount of the output current Iout flowing does not exceed the maximum output current Im, and the output voltage Vout decreases. Note that, the bonding resistor 202 is not taken into account, because a current flowing through the bonding resistor 202 is minute and a resistance of the bonding resistor 202 is much smaller than those of the resistors 105 and 106 and thus almost no voltage is generated. The maximum output current Im is determined by adjusting the bonding resistor 201 or the like so that the voltage of the bonding resistor 201 generated under the short-circuit may be equal to an offset voltage of the offset comparator 110.

In the normal state, the voltage at the non-inverting input terminal of the offset comparator 110 is set higher than the voltage at the inverting input terminal thereof because of the offset voltage, and hence the offset comparator 110 outputs Hi to turn OFF the PMOS transistor 103.

Here, various methods involving setting the offset voltage of the offset comparator 110 are known, such as varying the element size between input transistors, and any method may be employed.

In this way, overcurrent protection can be provided by detecting the output current by the bonding resistor 201. Then, the overcurrent protection can be provided without increasing current consumption caused by the increase in the output current.

### Third Embodiment

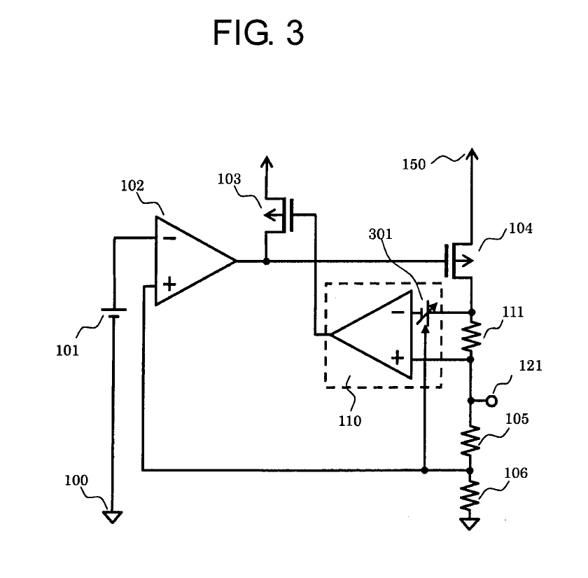

FIG. 3 is a circuit diagram of a voltage regulator according to a third embodiment of the present invention.

FIG. 3 is different from FIG. 1 in that an offset amount of the offset comparator 110 can be adjusted by the divided voltage Vfb.

Next, an operation of the voltage regulator of the third embodiment is described.

The resistors 105 and 106 output the divided voltage Vfb by dividing an output voltage Vout, which is a voltage at the output terminal 121. The differential amplifier circuit 102 compares the divided voltage Vfb with an output voltage Vref of the reference voltage circuit 101 to control a gate voltage of the PMOS transistor 104, which operates as an output transistor, so that the output voltage Vout becomes constant. When the output voltage Vout is higher than a predetermined voltage, the divided voltage Vfb is higher than the reference voltage Vref. Then, an output signal of the differential amplifier circuit 102 (gate voltage of the PMOS transistor 104) becomes higher to gradually turn OFF the PMOS transistor 104, and the output voltage Vout decreases. In this way, the output voltage Vout is controlled to be constant. On the other hand, when the output voltage Vout is lower than the predetermined voltage, an operation reverse to the above-mentioned operation is performed to increase the output voltage Vout. In this way, the output voltage Vout is controlled to be constant.

When the output terminal 121 and the ground terminal 100 are short-circuited, an output current Iout increases. When the output current Iout becomes an overcurrent state exceeding a maximum output current Im, a voltage generated by the resistor 111 increases, and the offset comparator 110 outputs Lo. Then, the PMOS transistor 103 is gradually turned ON, and a gate-source voltage of the PMOS transistor 104 decreases to gradually turn OFF the PMOS transistor 104. Accordingly, the amount of the output current Iout flowing does not exceed the maximum output current Im, and the output voltage Vout decreases. The maximum output current Im is determined by adjusting the resistor 111 so that the voltage of the resistor 111 generated under the short-circuit may be equal to an offset voltage 301 of the offset comparator 110.

In the normal state, the voltage at the non-inverting input terminal of the offset comparator 110 is set higher than the voltage at the inverting input terminal thereof because of the offset voltage 301, and hence the offset comparator 110 outputs Hi to turn OFF the PMOS transistor 103.

Regarding the offset voltage 301 of the offset comparator 110, the offset amount is adjusted by the divided voltage Vfb and by varying the element size between input transistors. In this way, the current value of the maximum output current Im can be further adjusted depending on the output voltage.

Here, the resistor 111 may use a wiring resistor.

Note that, although not illustrated, the offset voltage 301 of the offset comparator 110 may be adjusted by the voltage at the output terminal 121.

In this way, overcurrent protection can be provided by detecting the output current by the resistor 111. Then, the overcurrent protection can be provided without increasing current consumption caused by the increase in the output current. Besides, through the adjustment of the offset amount of the offset comparator 110, the current value of the maximum output current Im can be adjusted.

### Fourth Embodiment

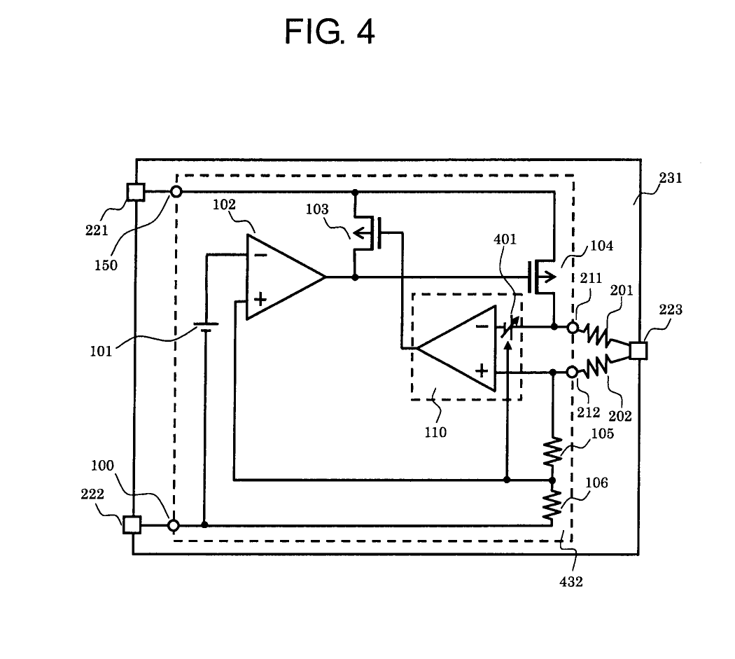

FIG. 4 is a circuit diagram of a voltage regulator according to a fourth embodiment of the present invention.

FIG. 4 is different from FIG. 2 in that an offset amount of the offset comparator 110 can be adjusted by the divided voltage Vfb.

Next, an operation of the voltage regulator of the fourth embodiment is described.

The resistors 105 and 106 output the divided voltage Vfb by dividing an output voltage Vout, which is a voltage at the package output terminal 223. The differential amplifier circuit 102 compares the divided voltage Vfb with an output voltage Vref of the reference voltage circuit 101 to control a gate voltage of the PMOS transistor 104, which operates as an output transistor, so that the output voltage Vout becomes constant. When the output voltage Vout is higher than a predetermined voltage, the divided voltage Vfb is higher than the reference voltage Vref. Then, an output signal of the differential amplifier circuit 102 (gate voltage of the PMOS transistor 104) becomes higher to gradually turn OFF the PMOS transistor 104, and the output voltage Vout decreases. In this way, the output voltage Vout is controlled to be constant. On the other hand, when the output voltage Vout is lower than the predetermined voltage, an operation reverse to the above-mentioned operation is performed to increase the output voltage Vout. In this way, the output voltage Vout is controlled to be constant.

When the package output terminal 223 and the package ground terminal 222 are short-circuited, an output current Iout increases. When the output current Iout becomes an overcurrent state exceeding a maximum output current Im, a voltage generated by the bonding resistor 201 increases, and the offset comparator 110 outputs Lo. Then, the PMOS transistor 103 is gradually turned ON, and a gate-source voltage of the PMOS transistor 104 decreases to gradually turn OFF the PMOS transistor 104. Accordingly, the amount of the output current Iout flowing does not exceed the maximum output current Im, and the output voltage Vout decreases. Note that, the bonding resistor 202 is not taken into account, because a current flowing through the bonding resistor 202 is minute and a resistance of the bonding resistor 202 is much smaller than those of the resistors 105 and 106 and thus almost no voltage is generated. The maximum output current Im is determined by adjusting the bonding resistor 201 or the like so that the voltage of the bonding resistor 201 generated under the short-circuit may be equal to an offset voltage 401 of the offset comparator 110.

In the normal state, the voltage at the non-inverting input terminal of the offset comparator 110 is set higher than the voltage at the inverting input terminal thereof because of the offset voltage 401, and hence the offset comparator 110 outputs Hi to turn OFF the PMOS transistor 103.

Regarding the offset voltage 401 of the offset comparator 110, the offset amount is adjusted by the divided voltage Vfb and by varying the element size between input transistors. In this way, the current value of the maximum output current Im can be further adjusted depending on the output voltage.

Note that, although not illustrated, the offset voltage 401 of the offset comparator 110 may be adjusted by the voltage at the package output terminal 223.

In this way, overcurrent protection can be provided by detecting the output current by the bonding resistor 201. Then, the overcurrent protection can be provided without increasing current consumption caused by the increase in the output current. Besides, through the adjustment of the offset amount of the offset comparator 110, the current value of the maximum output current Im can be adjusted.

What is claimed is:

1. A voltage regulator, comprising:
an error amplifier circuit for amplifying and outputting a difference between a reference voltage and a divided voltage obtained by dividing a voltage output by an output transistor, to thereby control a gate of the output transistor; and
an overcurrent protection circuit for monitoring an output current of the output transistor to protect the voltage regulator from an overcurrent,
wherein the overcurrent protection circuit comprises:
a sense resistor provided to a drain of the output transistor, for sensing the output current;
an offset comparator including an input terminal provided with an offset voltage, for comparing voltages at both terminals of the sense resistor; and
a first transistor including a gate connected to an output terminal of the offset comparator, and a drain connected to the gate of the output transistor.

2. A voltage regulator according to claim 1, wherein the sense resistor uses one of a wiring resistor and a bonding resistor.

3. A voltage regulator according to claim 1, wherein the offset comparator comprises an adjustment circuit for adjusting an offset amount based on a magnitude of the divided voltage.
